(19) United States
(12) Patent Application Publication
(10) Pub. No.: US 2014/0244491 A1
(43) Pub. Date: Aug. 28, 2014

(54) ACCELERATED PAYMENT COMPONENT FOR AN ELECTRONIC INVOICE PAYMENT SYSTEM

(71) Applicant: BOTTOMLINE TECHNOLOGIES (DE) INC., Portsmouth, NH (US)

(72) Inventors: Robert EBERLE, Portsmouth, NH (US); Amy HOKE, Gilford, NH (US); Lynne HERRMAN, Scarborough, ME (US); Michael MARCINELLI, North Andover, MA (US)

(73) Assignee: BOTTOMLINE TECHNOLOGIES (DE) INC., Portsmouth, NH (US)

(21) Appl. No.: 13/774,491

(22) Filed: Feb. 22, 2013

(51) Int. Cl. G06Q 20/10

(52) U.S. Cl. CPC G06Q 20/102
USPC 705/40

(57) ABSTRACT

An invoice payment acceleration system includes a database stored on a computer readable medium including a plurality of records, each record corresponding to an invoice issued by a vendor for payment from a buyer. A network interface is configured to receive a payment initiation command from a buyer for payment of an invoice to a vendor by a first payment method. A processor is configured to analyze the invoice as to which the payment command is received to determine whether the invoice satisfies one or more predetermined criteria. The processor further is configured, when the processor determines that the invoice satisfies the one or more predetermined criteria, to convert the first payment method to a second payment method, and the second payment method provides for an accelerated payment as compared to the first payment method. The criteria for acceleration may include vendor preferences, and/or terms of a subscription service.

### TECHNICAL FIELD

The present invention relates to an electronic invoice payment system, and more particularly to systems and methods for generating accelerated payments in such an electronic invoice payment system.

### BACKGROUND OF THE INVENTION

Traditional invoice presentment and payment solutions between vendors and their buyers include paper-based invoice presentment and payment. In this scenario, the steps required to send an invoice (on the vendor's side), and receive, approve, and pay the invoice (on the buyer's side) rely on a series of paper-based procedures. Recently, electronic invoicing and payment systems have been developed that provide on-line and network based invoice presentment by the vendor and electronic funds transfer (EFT) payment by the buyer.

A common system utilized for a variety of electronic funds transfers is the Automated Clearing House (ACH) system. ACH is an electronic network of participating financial institutions that processes large volumes of credit and debit transactions in high volume batches. The types of processed transactions are various, and include such financial transfers as payroll direct deposits, consumer electronic bill payments, debit and credit point-of-purchase transactions, and numerous others. Electronic vendor payments, in which buyers make payments to vendors for goods and services, is another common category of payments made via the ACH system.

In electronic invoice and payment systems, buyers (also referred to herein as payers) typically select the method or system of payment. Vendors, of course, would like to obtain payments as promptly as possible, but commonly become subject to a payer's selected processes for invoice approval and payment. With respect to ACH payments, typically there is a delay of at least one day between when the payment is initiated and settled with the vendor. Although a one-day delay may seem insignificant to a lay person, those skilled in the art understand that even a day's delay in which a vendor has not received payment results in an actual loss to the vendor. Particularly for vendors that may often receive high value payments, the accumulation of losses resulting from the delays from initiation to settlement of ACH payments can be substantial in total.

A wire transfer is an alternative method for electronic funds transfer. In contrast to ACH transactions, wire transfers tend to be more individualized transactions as compared to the bulk transfers commonly performed via the ACH system. Typical wire transfers have a timing advantage for vendors over ACH transactions, in that wire transfers typically are settled with near immediacy or near real time upon initiation by the payer. As such, the at least one day delay experienced in an ACH transaction typically does not occur when a transaction is performed via wire transfer. Accordingly, vendors would prefer to receive payments on invoices via wire transfer. As referenced above, however, it is generally the payer that chooses the method or system of payment, and wire transfers are selected by payers far less often than ACH transfers or other electronic transfers that may experience a delay between payment initiation and settlement. Conventional electronic invoice and payment systems, therefore, are deficient in that vendors lack control over receiving invoice payments via the most timely and efficient manner that may be available.

### SUMMARY OF THE INVENTION

There is a need in the art for an improved electronic invoice system and related methods that provide accelerated payments to vendors as compared to conventional payment systems. An aspect of the invention, therefore, is an improved electronic invoice system that has a payment acceleration feature. The payment acceleration feature accelerates the timing of an invoice payment to a vendor. In exemplary embodiments, the timing of the invoice payment is accelerated by converting an ACH transaction (or comparable transaction that has a delay to settlement) to a wire transfer (or comparable near-immediate settlement transaction) when specified criteria are satisfied.

Accordingly, an aspect of the invention is an invoice payment acceleration system. Embodiments of the invoice payment acceleration system include a database stored on a computer readable medium including a plurality of records, each record corresponding to an invoice issued by a vendor for payment from a buyer. A network interface is configured to receive a payment initiation command from a buyer for payment of an invoice to a vendor by a first payment method. A processor is configured to analyze the invoice as to which the payment command is received to determine whether the invoice satisfies one or more predetermined criteria. The processor further is configured, when the processor determines that the invoice satisfies the one or more predetermined criteria, to convert the first payment method to a second payment method, and the second payment method provides for an accelerated payment as compared to the first payment method. The criteria for acceleration may include vendor preferences, and/or terms of a subscription service.

In exemplary embodiments of the invoice payment acceleration system, the one or more predetermined criteria comprises vendor preference criteria received from a vendor via the network interface.

In exemplary embodiments of the invoice payment acceleration system, the vendor preference criteria are stored in the database.

In exemplary embodiments of the invoice payment acceleration system, the vendor preference criteria include at least one of a minimum payment amount threshold, a buyer identity, an invoice number, or a timing of the invoice.

In exemplary embodiments of the invoice payment acceleration system, the invoice payment acceleration system is operated by a service provider, and the one or more predetermined criteria comprises service provider terms selected by the service provider.

In exemplary embodiments of the invoice payment acceleration system, the service provider terms criteria are stored in the database.

In exemplary embodiments of the invoice payment acceleration system, the service provider terms criteria include at least one of a minimum threshold of processing fees, a maximum quantity amount of accelerations per unit time, or a maximum invoice dollar amount per unit time.

In exemplary embodiments of the invoice payment acceleration system, the one or more predetermined criteria includes whether or not the second accelerated payment method is available for processing the payment.

In exemplary embodiments of the invoice payment acceleration system, the first payment method is an automated clearing house transaction and the second payment method is a wire transfer.

In exemplary embodiments of the invoice payment acceleration system, the processor is configured to convert the payment method from the first payment method to the second payment method automatically when the invoice is determined to satisfy the one or more predetermined criteria.

In exemplary embodiments of the invoice payment acceleration system, the processor further is configured, when the processor determines that the invoice satisfies the one or more predetermined criteria, to generate an acceleration alert to alert the vendor that the invoice is subject to acceleration. The network interface further is configured to transmit the acceleration alert to the vendor, and the network interface further is configured to receive an acceleration command from the vendor to accelerate the payment. The processor further is configured to convert the first payment method to the second payment method in response to receipt of the acceleration command.

In exemplary embodiments of the invoice payment acceleration system, the processor further is configured to cause the payment to be processed in accordance with the first payment method when the invoice does not satisfy the one or more predetermined criteria.

In exemplary embodiments of the invoice payment acceleration system, the processor further is configured to cause the payment to be processed in accordance with the first payment method when an acceleration command is not received.

In exemplary embodiments of the invoice payment acceleration system, the processor further is configured to determine whether the invoice satisfies a first criteria from among the one or more predetermined criteria, and convert the payment method from the first payment method to the second payment method automatically when the invoice is determined to satisfy the first criteria.

In exemplary embodiments of the invoice payment acceleration system, the processor further is configured, when the invoice does not satisfy the first criteria, to determine whether the invoice satisfies a second criteria from among the one or more predetermined criteria. The processor further is configured, when the processor determines that the invoice satisfies the second criteria, to generate an acceleration alert to alert the vendor that the invoice is subject to acceleration. The network interface further is configured to transmit the acceleration alert to the vendor, and the network interface further is configured to receive an acceleration command from the vendor to accelerate the payment. The processor further is configured to convert the first payment method to the second payment method in response to receipt of the acceleration command.

In exemplary embodiments of the invoice payment acceleration system, the first criteria is a first threshold value of an invoice payment amount, and the second criteria is a second threshold value of an invoice payment amount, wherein the first threshold value is greater than the second threshold value.

Another aspect of the invention is an electronic invoice and payment system. Exemplary embodiments of the electronic invoice payment system include the described invoice payment acceleration system, and an invoice payment system configured to process the payment in accordance with the second accelerated payment method when the processor determines that the invoice satisfies the one or more predetermined criteria.

In exemplary embodiments of the electronic invoice and payment system, the processor further is configured to cause the payment to be processed in accordance with the first payment method when the invoice does not satisfy the one or more predetermined criteria, and the invoice payment system is configured to process the payment in accordance with the first payment method when the processor determines that the invoice does not satisfy the one or more predetermined criteria.

Another aspect of the invention is a method of accelerating an invoice payment in an electronic invoice payment system. Exemplary embodiments of the method of accelerating an invoice payment include the steps of: storing a database on a non-transitory computer readable medium, the database including a plurality of records, each record corresponding to an invoice issued by a vendor for payment from a buyer, receiving a payment initiation command over a network interface from a buyer for payment of an invoice to a vendor by a first payment method, and providing a payment acceleration application on a non-transitory computer readable medium, which when executed by a processor performs the steps of: analyzing the invoice as to which the payment command is received to determine whether the invoice satisfies one or more predetermined criteria, and when it is determined that the invoice satisfies the one or more predetermined criteria, converting the first payment method to a second payment method, and the second payment method provides for an accelerated payment as compared to the first payment method.

In exemplary embodiments of the method of accelerating an invoice payment, the payment acceleration application when executed by the processor further performs the steps of: when it is determined that the invoice satisfies the one or more predetermined criteria, generating an acceleration alert to alert the vendor that the invoice is subject to acceleration, transmitting the acceleration alert to the vendor via the network interface, receiving an acceleration command from the vendor via the network interface to accelerate the payment, and converting the first payment method to the second payment method in response to receipt of the acceleration command.

A number of features are described herein with respect to embodiments of the invention. It will be appreciated that features described with respect to a given embodiment also may be employed in connection with other embodiments. In addition, for a better understanding of the present invention, together with other and further aspects thereof, reference is made to the following description, taken in conjunction with the accompanying drawings. The scope of the invention is set forth in the appended claims, which set forth in detail certain illustrative embodiments. These embodiments are indicative, however, of but a few of the various ways in which the principles of the invention may be employed.

### BRIEF DESCRIPTION OF THE DRAWINGS

FIG. 1 is a schematic block diagram depicting an exemplary architecture of an electronic invoice presentment and payment system, including an exemplary payment acceleration system, in accordance with an exemplary embodiment of the present invention.

FIG. 2 is a schematic block diagram representing a buyer system in accordance with an exemplary embodiment of the present invention.

FIG. 3 is a schematic block diagram representing a vendor system in accordance with an exemplary embodiment of the present invention.

FIG. 4A is a diagram representing an invoice database structure in accordance with an exemplary embodiment of the present invention.

FIG. 4B is a diagram representing an invoice database object in accordance with an exemplary embodiment of the present invention.

FIG. 5 is a flow chart diagram depicting an overview of an exemplary method of accelerating a payment settlement in an invoice payment system.

FIG. 6 is a flow chart diagram depicting an overview of a modified exemplary method of accelerating a payment settlement in an invoice payment system.

FIG. 7 is a diagram depicting an exemplary graphical user interface (GUI) for use in connection with an invoice payment system.

FIG. 8 is a ladder diagram depicting an exemplary embodiment of operation of a payment acceleration system for accelerating an invoice payment in an invoice payment system.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should be appreciated that many of the elements discussed in this specification may be implemented in a hardware circuit(s), a processor executing software code or instructions that are encoded within non-transitory computer readable media accessible to the processor, or a combination of a hardware circuit(s) and a processor or control block of an integrated circuit executing machine readable code encoded within a non-transitory computer readable medium. As such, the term circuit, module, server, application, or other equivalent description of an element as used throughout this specification is, unless otherwise indicated, intended to encompass a hardware circuit (whether discrete elements or an integrated circuit block), a processor or control block executing code encoded in a non-transitory computer readable medium, or a combination of a hardware circuit(s) and a processor and/or control block executing such code.

The present invention provides a system and method for accelerating an electronic payment to a vendor from a payer or buyer. In exemplary embodiments, the system converts the method of payment from a first payment method selected by the payer to a second accelerated payment method select and preferred by the vendor. The second method of payment preferred by the vendor typically would be an accelerated method of payment as compared to the first method of payment selected by the buyer, in that the time period between payment initiation and settlement is shorter for the second payment method as compared to the first payment method. For example, the system may convert and accelerate the payment method from an ACH transaction, as selected by the payer, to a wire transfer as preferred by the vendor to reduce the time period to settlement. In this manner, the system accelerates the payment to the vendor to provide the near immediacy of settlement of a wire transfer and avoid the delay in settlement that typically would occur if the payment were processed as an ACH transfer as usually selected by the buyer.

The system may convert and accelerate the method of payment automatically based on one or more predetermined criteria. For example, the system may be configured to accelerate a payment transaction based upon a specified minimum dollar amount, payer identity, a specified number of payments per unit time period (e.g., month, quarter, etc.), and/or other criteria as may be deemed suitable. In other embodiments, the system may be configured to provide an alert to a vendor that a payment transaction has been initiated that satisfies one or more of the predetermined criteria. The system further may be configured to receive an input from the vendor as to whether or not such a payment transaction is to be accelerated or not. The system will then process the payment transaction in accordance with either the first or original selected method of payment selected by the payer, versus the second or accelerated method of payment, based on the input from the vendor as to whether to convert the payment method.

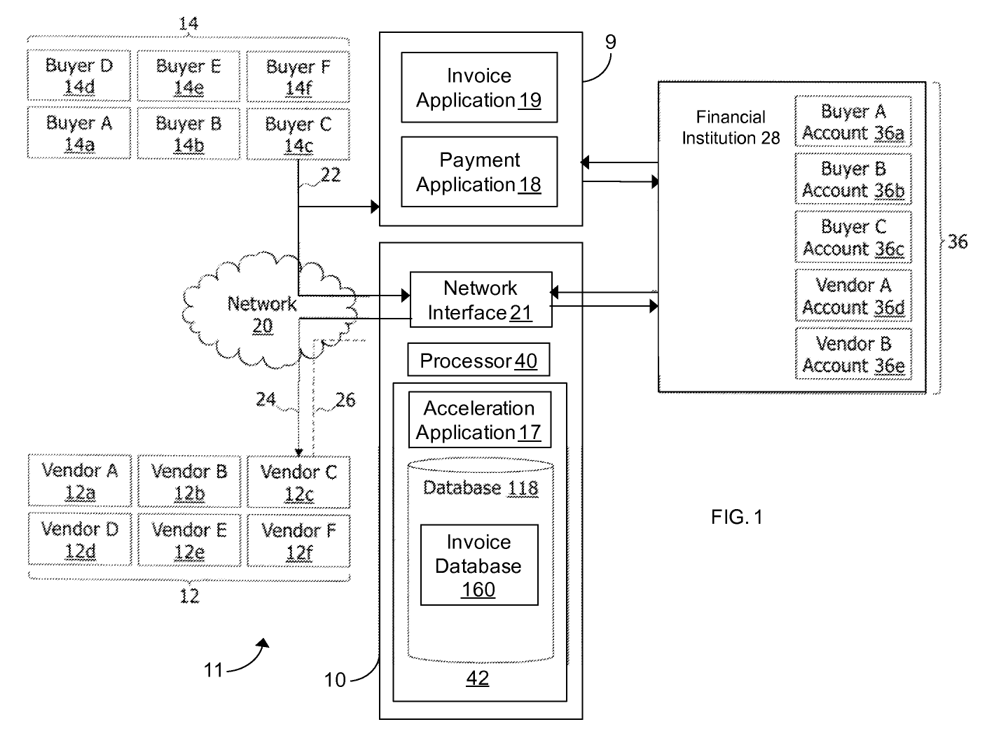

FIG. 1 depicts an exemplary architecture 11 for electronic invoicing, including an electronic invoicing and payment system 9 that operates in conjunction with a payment acceleration system 10. The exemplary electronic invoicing and payment system 9 may include a payment application 18 and an invoice application 19, each of which may be instructions coded and stored on a non-transitory computer readable medium and executed by a processing device. The electronic invoicing and payment system 9 (sometimes referred to herein in short form as invoice payment system 9) provides on-line invoice presentment that includes modules for reporting invoice approval and payment status to the vendors 12. In general, the invoice application 19 electronically delivers invoices initiated by a vendor 12 to the applicable buyer 14, and includes a reporting function that provides vendors connected to the payment acceleration system 10 with invoice status information. For example, a vendor may submit an invoice to a buyer via the invoicing application. The invoice may then be automatically entered into an accounts receivable system of the buyer. In one example, the status of the invoice may be updated to “received” such that the vendor may view the status of the invoice to verify that the invoice has been received by the buyer. At this point, the buyer may approve the invoice for payment and the status of the invoice may be updated again to indicate approval for payment, which the vendor may view. Upon approving the invoice for payment, the invoice payment system 9 may execute payment from the buyer's financial account, such as a bank or credit account, to the vendor. For this purpose, the invoice payment system 9 and payment acceleration system 10 may be communicatively coupled to a financial institution in which the buyer has an account or credit line, such as the financial institution 28 in FIG. 1.

An exemplary electronic invoicing and payment system is further described in U.S. patent application Ser. No. 13/068,558 filed on May 13, 2011, the entire contents of which are incorporated by reference herein. Other exemplary invoice and payment systems include systems that utilize the ACH system referenced above, wire transfers, electronic check and bank transfers, and other electronic fund transfer (EFT) systems that may be part of card payment networks, such as networks operated by Visa, MasterCard, and American Express, and the like.

Turning again to FIG. 1, as referenced above the electronic invoicing and payment system 9 may operate in conjunction with a payment acceleration system 10. The payment acceleration system 10 may be a computer system including one or more servers comprising at least a processor 40, a network interface 21, and computer readable medium 42. The computer readable medium 42 may be a non-transitory computer readable medium that includes encoded thereon a payment acceleration application 17 and a database 118. The payment acceleration application 17 may be a computer program comprising instructions embodied on the computer readable medium 42 and executed by the processor 40. The database 118 may include data structures, also referred to as tables, as described herein and may include instructions embodied on computer readable medium 42 for interfacing with the network interface 21 and the payment acceleration application 17 for reading and writing data to the data structures and tables.

The network interface 21 may be communicatively coupled to each buyer 14a-14f of a community of buyers 14, and to each vendor 12a-12f of a community of vendors 12 via a network 20. It will be appreciated that the specific number and nature of the vendors 12 and buyers 14 may vary substantially. The network 20 may be an open network, such as the Internet, a private network, such as a virtual private network, or any other suitable network. The network interface 21 may receive invoices and invoice updates from the vendors 12 and/or buyers 14. For example, the network interface 21 may be configured to enable, for a given invoice, updating of the status of at least one event associated with approval and payment of the given invoice based on a received invoice update. The network interface 21 may include a wireless network adaptor, an Ethernet network card, or any suitable device that provides an interface between the payment acceleration system 10 and the network 20.

The invoices and invoice updates received by the network interface 21 may be stored in an invoice database 160 contained in the database 118. The invoices may be stored in the invoice database 160 as records. Each record corresponds to an invoice and may identify an associated vendor, an associated buyer, and contain status information. The invoice database may store records corresponding to different combinations of associated vendors and buyers. The status information may correspond to activity of the associated buyer and/or vendor in relation to a given invoice and may include any combination of a current status, a current status update timestamp indicating the date when the invoice status was last updated, a list of past statuses, and, for each of the past statuses in the list of past statuses, a past status timestamp indicating the date when the past status was updated.

The records stored in the invoice database 160 may correspond to invoices for which payment has been received (“paid invoices”) and/or invoices for which payment has not been initiated (“unpaid invoices”). The invoice status updates received by the network interface 21 may be used to update the status of invoices stored in the invoice database 160. For example, the invoice updates may include a status update that payment for a given invoice was initiated. Under such circumstances, the status of an invoice may be altered from “unpaid invoice” to “payment initiated” invoice. Upon final settlement of the payment transaction, the status of an invoice may then be updated again to “payment received”. The timestamp associated with the various statuses are updated commensurately with the status updates to indicate, for example, when payment was initiated and when payment has been received (i.e., settled).

As will be understood by those of ordinary skill in the art, the database 118 may describe a data structure which embodies groups of records or data elements stored in a volatile or non volatile storage media and accessed by an application, which may be instructions coded to a storage medium and executed by a processor. The database may include multiple individual databases stored on the same storage medium or on multiple different storage media. The payment acceleration system 10 may also store data in and access the database. While the database 118 is depicted as a component of the payment acceleration system 10 in FIG. 1, the database 118 could alternatively be stored on a separate server or locally, for example, on a buyer's computer and/or on a vendor's computer.

The processor 40 may constitute an electronic controller that is configured to carry out overall control of the functions and operations of the payment acceleration system 10. The processor 40 may include a processing device such as a CPU, microcontroller or microprocessor. To implement the features of the present invention, the processor may be configured to execute program code embodied as the payment acceleration application 17. It will be apparent to a person having ordinary skill in the art of computer programming of electronic devices and servers how to program the components of the payment acceleration system to operate and carry out logical functions associated with the payment acceleration application 17.

Accordingly, details as to specific programming code have been left out for the sake of brevity. Also, controller functionality could be carried out via dedicated hardware, firmware, software, or any combinations thereof, without departing from the scope of the invention. As will be understood by one of ordinary skill in the art, therefore, the processor 40 may have various implementations. For example, the processor 40 may include any suitable device, such as a programmable circuit, integrated circuit, memory and I/O circuits, an application specific integrated circuit, microcontroller, complex programmable logic device, other programmable circuits, or the like. The processor 40 may also include a non-transitory computer readable medium, such as random access memory (RAM), a read-only memory (ROM), an erasable programmable read-only memory (EPROM or Flash memory), or any other suitable medium. Instructions for performing the method described below may be stored in the non-transitory computer readable medium and executed by the processor.

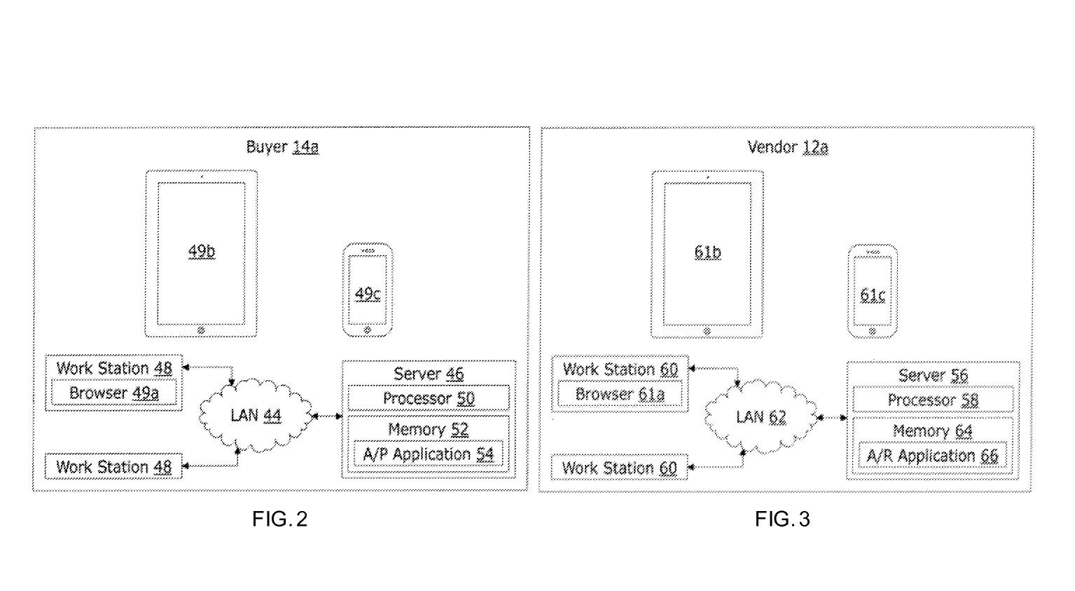

Referring to FIG. 2 in conjunction with FIG. 1, in an exemplary embodiment, each buyer, such as buyer 14a for example, may be a business that includes at least one computer system or server 46. The computer system(s) or server(s) 46 may include at least one processor 50 and associated computer readable medium 52 programmed with an accounts payable application 54. In a typical environment, the computer system(s) or server(s) 46 operating the accounts payable application 54 may be coupled to a local area network (LAN) 44 and accessed by entitled users of workstations 48 and may be used for managing the buyer's accounts payables and issuing payments to its vendors. Each buyer, again using buyer 14a as an example, may further include one or more access systems for interfacing with the payment acceleration system 10. Exemplary access systems include: i) a web browser 49a on a workstation 48 or other computer which accesses system 10 via a web connection; ii) a tablet computer 49b such as an iPad or Windows Surface which accesses the system 10 utilizing a custom client application on the tablet; and iii) other mobile devices 49c such as smart phones which access the system 10 utilizing a custom client application on the mobile device, in each case over permutations of the internet, wired or wireless internet service provider networks, and a local area network.

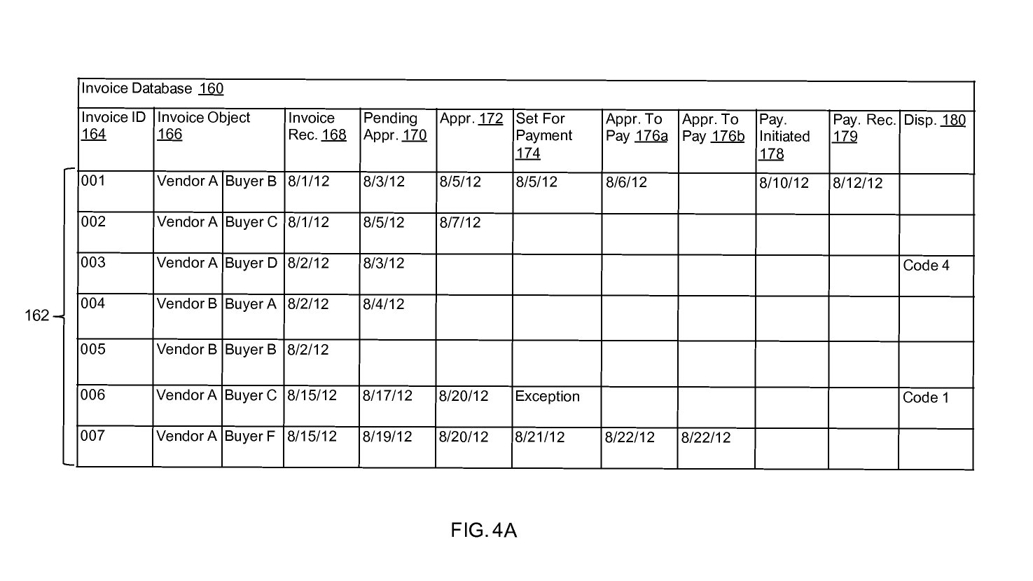

Referring to FIG. 3 in conjunction with FIG. 1, in an exemplary embodiment, each vendor, such as vendor 12a for example, may be a business that includes at least one computer system or server 56. The computer system(s) or server(s) 56 may include at least one processor 58 and associated computer readable medium 64 programmed with an accounts receivable application 66. In a typical environment, the computer system(s) or server(s) 56 operating the accounts receivable application 66 may be coupled to a local area network (LAN) 62 and accessed by entitled users of workstations 60 and may be used for issuing invoices and managing the vendor's accounts receivables and reconciling payments issued by customers (i.e. buyers) against amounts due to the vendor. Each vendor, again using vendor 12a as an example, may further include one or more access systems for interfacing with the system 10. Similarly as to the buyers, exemplary vendor access systems include: i) a web browser 61a on a workstation 60 or other computer which accesses system 10 via a web connection; ii) a tablet computer 61b such as an iPad or Windows Surface which accesses the system 10 utilizing a custom client application on the tablet; and iii) other mobile devices 61c such as smart phones which access the system 10 utilizing a custom client application on the mobile device, in each case over permutations of the internet, wired or wireless internet service provider networks, and a local area network.

Returning to FIG. 1, for purposes of illustrating the invention, a participating financial institution 28 is depicted. The financial institution 28 may be a bank or like institution that can hold accounts of the vendor and buyers and process payment transactions. The financial institution 28 may include a payment system (i.e. instructions coded to a computer readable medium and executed by a processor) which may manage customer deposit accounts 36 for at least a portion buyers 14 and/or a portion of the vendors 12, including execution of credit and debit transactions to specific deposit accounts 36a-36e in a traditional manner.

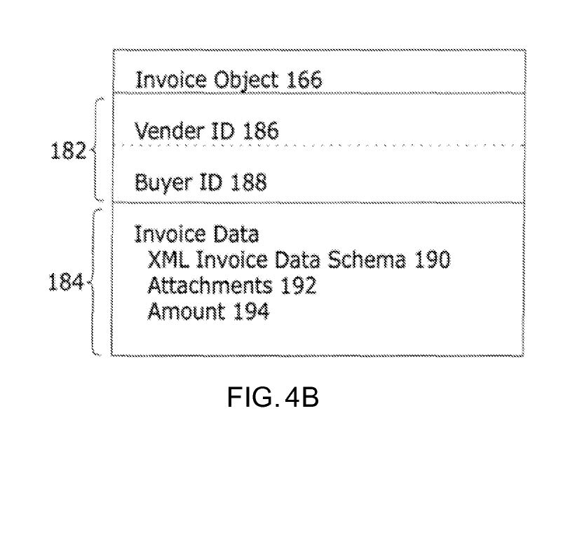

Referring to FIG. 4A in conjunction with FIG. 1, the database 118 may further include, as one of the data structures, the invoice database 160 as described previously. The invoice database 160 may include a plurality of records 162, with each record 162 corresponding to an invoice. Each invoice 162 associates a unique invoice ID 164 with a unique invoice object 166 and a group of exemplary status fields. In the exemplary embodiment of FIG. 4A, the status fields may include an invoice received status field 168, a pending invoice approval status field 170, an invoice approved status field 172, a set for payment status field 174, a first approved to pay status field 176a, a second approved to pay status field 176b, a payment initiated status field 178, a payment received field 179, and a disputed invoice status field 180. As stated previously, the invoice status is not limited to the above listed statuses. For example, the invoice statuses may fall under one of three global statuses (e.g., in process, rejected for processing, ready for payment). As another example, the invoice statuses may include default statuses and/or user defined statuses.

Each status field represents a completed step within a group of processing steps the buyer performs to approve and pay the invoice, whether within the invoice application 19 itself or within the buyer's accounts payable system 43 (FIG. 2) (or both) represented by the record 162. For example, the invoice received status field 168 may represent an initial step at which the buyer has completed receipt of the invoice into his accounts payable system. Additionally, the pending approval status field 170 may represent steps following receipt of the invoice which are performed by the buyer prior to formal approval of the invoice. The approved status field 172 may represent formal approval of the invoice. The set for payment status field 174 may represent a step of setting the payment of the invoice. The first approved to pay status field 176a may represent approval of the payment. The second approved to pay status field 176b may be an optional step representing a second level approval of the payment. The optional step 176b may apply based on the buyer's approval rules, for example, high value payments may require a second level of approval. The payment initiated status field 178 may represent the buyer initiating the payment through the payment acceleration system 10, such as by issuing a payment order. The payment received status field 179 may represent the vendor's receipt of the payment through the payment acceleration system 10. The disputed status field 180 may represent the buyer disputing all or a portion of the invoice.

Each status field may operate as a status flag for that processing step in that whether the value is populated, or whether a particular value is populated, indicates whether the buyer has completed the processing step. In the exemplary embodiment, each of the status fields may be populated with the status timestamp (i.e., the date and time that the process was completed).

Referring to FIG. 4B, an exemplary invoice object 166 may include a header 182 and a body 184. The header 182 may include a vendor ID 186 and a buyer ID 188 identifying the vendor issuing the invoice and the buyer to which the invoice is delivered. The body 184 of the invoice object includes invoice data. The invoice data may include data components of a standardized XML data schema 190, which may be an invoice data schema standardized by the ISO 20022 standard. The invoice data may also include attachments 192, which would typically be PDF files but could be attachments in other file formats, which provide more detailed information about invoice line items. The invoice object 166 also may include an amount field 194 indicating the amount of the invoice.

Referring again to FIG. 4A, within the records 162 of the invoice database 160 are invoice objects 166 as depicted in FIG. 4B, such as at least a first invoice object (Invoice ID 001 for example) which includes identification of a first vendor (Vendor A for example) and at least a second invoice object (Invoice ID 004 for example) which includes identification of a second vendor (Vendor B for example) unique from the first vendor. Each vendor is a distinct organization with responsibility for issuing and collecting on its own invoices. Also within the records 162 of the invoice database 160 are at least a first invoice object (Invoice ID 001 for example) which includes identification of a first buyer (Buyer B for example) and at least a second invoice object (Invoice ID 002 for example) which includes identification of a second buyer (Buyer C for example) unique from the first buyer. Each buyer is a distinct organization with responsibility for payment of invoices distinct from other buyers. In this manner, vendor invoices are associated with respective buyers via the invoice objects 166.

For example, the record 162 with an invoice ID 164 of “001” may include an invoice 166 issued by Vendor A to Buyer B. For purposes of illustrating the invention, it is assumed that all processes have been completed and a date is populated to each field. A second level approval step 176b is not required. The record 162 with an invoice ID of “002” may include an invoice 166 issued by Vendor A to Buyer C. For purposes of illustrating the invention, it is assumed that Buyer C has performed only the first three sequential processing steps (invoice received 168, pending approval 170, and pending approval 172). As such, dates are populated for invoice received 168, pending approval 170 and pending approval 172. A second level approval step 176b is not required.

The additional records with invoice IDs 003 on may be described in similar fashion. Specifically, the record 162 with an invoice ID of “003” may include an invoice 166 issued by Vendor A to Buyer D. For purposes of illustrating the invention, it is assumed that Buyer D has a dispute regarding this invoice. As such only a date is populated to the invoice received status field 168 and a dispute code “Code 4” is populated to the disputed field. A dispute code table 300 may associate a group of dispute codes, for example dispute codes “Code 1”, “Code 2”, “Code 3”, and “Code 4” with a dispute reason. For example, “Code 1” may represent dispute a first reason “Reason A” and “Code 2” may represent a second dispute reason “Reason B”, which is distinct from dispute “Reason A”. A fourth dispute reason “Code 4” may be generic and represent buyer text input of a message to the vendor regarding the basis for the dispute.

The record 162 with an invoice ID of “004” may include an invoice 166 issued by Vendor B to Buyer A. For purposes of illustrating the invention, it is assumed that Buyer A has performed only the first two sequential processing steps (invoice received 168 and pending approval 170). As such, dates are populated for invoice received 168 and pending approval 170. A second level approval step 176b is required for this invoice.

The record 162 with an invoice ID of “005” may include an invoice 166 issued by Vendor B to Buyer B. For purposes of illustrating the invention, it is assumed that Buyer B has performed only the first processing step (invoice received 168). As such, dates are populated for invoice received 168 and pending approval 170. A second level approval step 176b is required for this invoice.

The record 162 with an invoice ID of “006” may include an invoice 166 issued by Vendor A to Buyer B. For purposes of illustrating the invention, it is assumed that Buyer C has performed only the first three sequential processing steps (invoice received 168, pending approval 170, and pending approval 172). As such, dates are populated for invoice received 168, pending approval 170 and pending approval 172. A second level approval step 176b is not required.

The record 162 with an invoice ID of “007” may include an invoice 166 issued by Vendor A to Buyer F. For purposes of illustrating the invention, it is assumed that the second level approval step 176b is required and that Buyer F has performed all of the sequentially processing steps, including second level pending approval to pay 176b, except for the payment initiated Step 178. As such, dates are populated for invoice received 168, pending approval 170, pending approval 172, set for payment 174, first level pending approval to pay 176a, and second level pending approval to pay 176b.

As referenced above, one deficiency of conventional invoice payment systems for vendors is that vendors typically lack control over the method of payment selected by a buyer. Even when a buyer selects to pay an invoice by some form of electronic funds transfer, such as an ACH transaction, a delay between payment initiation (see FIG. 4A, block 178) and payment received or settled (see FIG. 4A, block 179) can result in decreased value to the vendor. Accordingly, the present invention overcomes such deficiency by providing a system and methods for accelerating payment settlement to a payment method with a reduced delay as compared to the method of payment initially selected by a buyer.

An aspect of the invention, therefore, is an invoice payment acceleration system, such as the payment acceleration system 10. Exemplary embodiments of the payment acceleration system include a database stored to a non-transitory computer readable medium, such as the database 118 storing the database of invoice records 160. The database includes a plurality of such records, each record corresponding to an invoice issued by a vendor for payment from a buyer. A network interface, such as network interface 21, is configured to receive a payment initiation command from a buyer for payment of an invoice to a vendor by a first payment method. A processor, such as processor 40, is configured to analyze the invoice as to which the payment command is received to determine whether the invoice satisfies one or more predetermined criteria. The processor further is configured, when the processor determines that the invoice satisfies the one or more predetermined criteria, to convert the first payment method to a second payment method, and the second payment method provides for an accelerated payment as compared to the first payment method. The processor may be configured to perform such operations by the execution of a payment acceleration application, such as payment acceleration application 17.

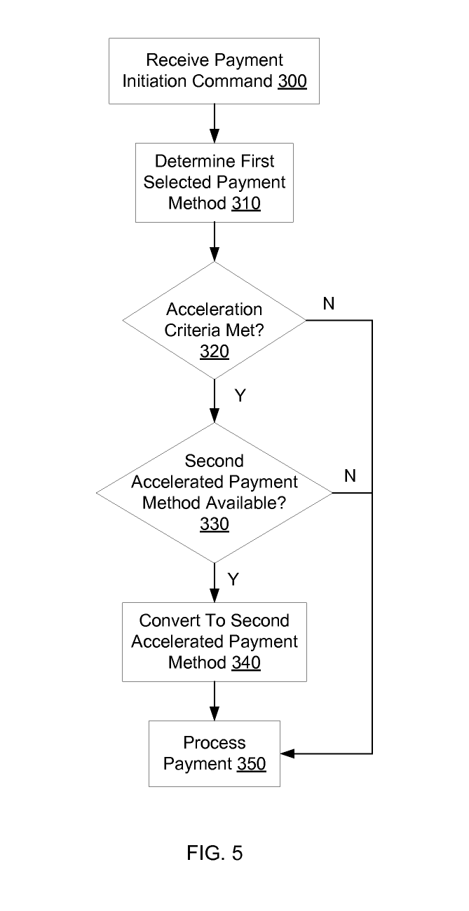

As illustrative of the operation of such a payment acceleration system 10, FIG. 5 is a flow chart diagram depicting an overview of an exemplary method of accelerating a payment settlement in an invoice transaction system. In exemplary embodiments, the payment acceleration system 10 of FIG. 1 is configured to execute the described method, such as by the processor 40 executing code embodied as the payment acceleration application 17 stored on the non-transitory computer readable medium 42. Accordingly, in demonstrating the method, reference also is made to the invoice payment system as depicted in FIG. 1, which includes the payment acceleration system 10. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

The method may begin at step 300, at which a payment initiation command is received by the payment acceleration system from a buyer, which indicates a first payment method for paying the invoice. Referring to the system of FIG. 1, a buyer 14 may execute a payment initiation command at a buyer workstation as to any invoice issued by a vendor 12 for which payment has come due. The payment acceleration system 10 may receive the payment initiation command via the network interface 21 over the network 20. At step 310, the payment acceleration system 10 determines the selected payment method, again referred to as the first payment method. As referenced above, typically such first payment method initially would be selected by the buyer.

At step 320, the payment acceleration system 10 determines whether or not the invoice associated with the payment meets one or more predetermined criteria. The payment acceleration system may analyze the invoice as part of the processor 40 executing the payment acceleration application 17. Certain criteria may be based on vendor preferences. The payment application system 10 may receive vendor preference criteria that have been inputted by the vendor at a vendor workstation. The vendor preference criteria may be received by the system 10 via the network interface 21, and such criteria may be stored as part of the database 118 for use in the analysis by the processor 40.

Various vendor preference criteria may be employed to determine whether a payment may be subject to payment acceleration. For example, because the significance of payment acceleration increases with invoice amount, one exemplary criterion may be whether the payment amount exceeds a minimum payment amount threshold. A suitable payment amount threshold may be $50,000.00, $150,000.00, or any suitable amount as determined by the vendor to be significant for purposes of payment acceleration. Another exemplary criterion may be buyer identity, should a vendor wish to accelerate all or a portion of payments received from a particular buyer. Another criterion may be whether the invoice exceeds a predetermined invoice number, should a vendor wish to accelerate all payments after a certain number of invoice payments have been received (from either a same or multiple buyers). Another criterion may be the timing of the invoice (e.g., date, month, quarter, etc.), should the vendor wish to accelerate payments during a particular time period or periods of the year.

In exemplary embodiments, the payment acceleration system 10 may be operated by a third party service provider that processes invoices for a paid fee or subscription. In such a system, service provider terms criteria for triggering payment acceleration may be based on terms of a subscription or service contract. For example, one criterion for payment acceleration based on service provider terms criteria may be whether the vendor has paid to the service provider a minimum threshold of processing fees. An example of such fees may be an acceleration subscription fee (such as a one-time fee or periodic fee), or the like. The service provider operating the payment acceleration system may then provide for acceleration of payments to vendors who have satisfied any requisite minimum threshold of subscription or other service processing fee payments.

Relatedly in a service provider system, the service provider subscription to the vendor may permit acceleration of payments up to a maximum quantity amount or number of invoices per unit time as permitted by the vendor's subscription terms. For example, the terms of a subscription may include a maximum quantity amount in the form of a monthly quantity amount (or e.g., quarterly amount, yearly amount, etc.) of permissible payment accelerations per the applicable unit time. The number of permissible payment accelerations may be increased with the payment of additional service fees paid by the vendor to the service provider, and otherwise based on subscription or like service fees. In such a system, one criterion may be whether the vendor remains under the maximum permissible number of payment accelerations allowed by the subscription terms. A similar criterion may be a maximum dollar amount of total invoice value per unit time (e.g., monthly, quarterly, yearly, etc.) that can be accelerated under the terms of the subscription. The dollar amount value of permissible payment accelerations similarly may be increased with the payment of additional service fees paid by the vendor to the service provider, and otherwise based on subscription or like service fees.

It will be appreciated that the various criteria described above are but examples. Any suitable criteria may be employed for triggering payment acceleration. In addition, criteria may be applied singularly or in any combination of multiple criteria, including combining one or more vendor preferences with one or more subscription terms set by a service provider.

Referring again to FIG. 5, if at step 320 the payment acceleration system renders a “No” determination, indicating that the invoice does not meet the one or more predetermined criteria, the method proceeds to step 350 at which the payment is processed. In such case, there being no basis to accelerate the payment, the payment would be processed in accordance with the first payment method that initially was selected. Again, this initial first payment method typically is the payment method selected by the buyer. For example, the processor 40 of the payment acceleration system 10 may generate a processing signal and transmit such signal to the electronic invoicing and payment system 9, which would execute the payment with the payment application 19 to process the payment in accordance with the first payment method.

If at step 320, however, the payment acceleration system renders a “Yes” determination, indicating that the invoice does in fact meet the one or more predetermined criteria, the method proceeds to step 330. At step 330, the payment acceleration system 10 determines as an additional criterion whether or not a second accelerated payment method is available for processing the payment. If at step 330 the payment acceleration system renders a “No” determination, indicating that there is no available second method for payment acceleration, the method proceeds to step 350 at which the payment is processed. In such case, there being no available alternative second method to accelerate the payment, the payment would be processed by the payment system 9 in accordance with the first payment method that initially was selected. Again, this initial first payment method typically is the payment method selected by the buyer.

If at step 330, however, the payment acceleration system renders a “Yes” determination, indicating that there is in fact an available second payment method to accelerate the payment, the method proceeds to step 340. At step 340, the payment acceleration system 10 converts the payment method from the first payment method that was initially selected to the second accelerated payment method. Generally, if the first payment method has a delay period to settlement, and the second payment method has a shorter delay period or near-immediate settlement period, the system will convert the payment method from the first payment method to the second accelerated payment method. For example, if the first payment method is an ACH transaction that typically has at least a one-day delay to settlement, and the system determines that a wire transfer which has near immediate settlement is available, at step 340 the system will convert the payment method from an ACH transaction to a wire transfer so as to accelerate the payment. If multiple accelerated payment methods may be available, the system may default to convert the payment method to the most accelerated payment method having the shortest settlement period from among available options.

Upon such conversion, the method then proceeds to step 350 at which the payment is processed. If the payment method has been converted at step 340 from the initially selected first payment method to a second accelerated payment method, at step 350 the payment will be processed in accordance with the second accelerated payment method. For example, the processor 40 of the payment acceleration system 10 may generate a processing signal and transmit such signal to the electronic invoicing and payment system 9, which would execute the payment with the payment application 19 in accordance with the second, accelerated payment method.

It is noted that in the operation of the payment acceleration system 10 in accordance with the process of FIG. 5, the processor is configured to convert the payment method from the first payment method to the second payment method automatically when the invoice is determined to satisfy the applicable one or more criteria. Automatic acceleration thus is one mode of operation the system.

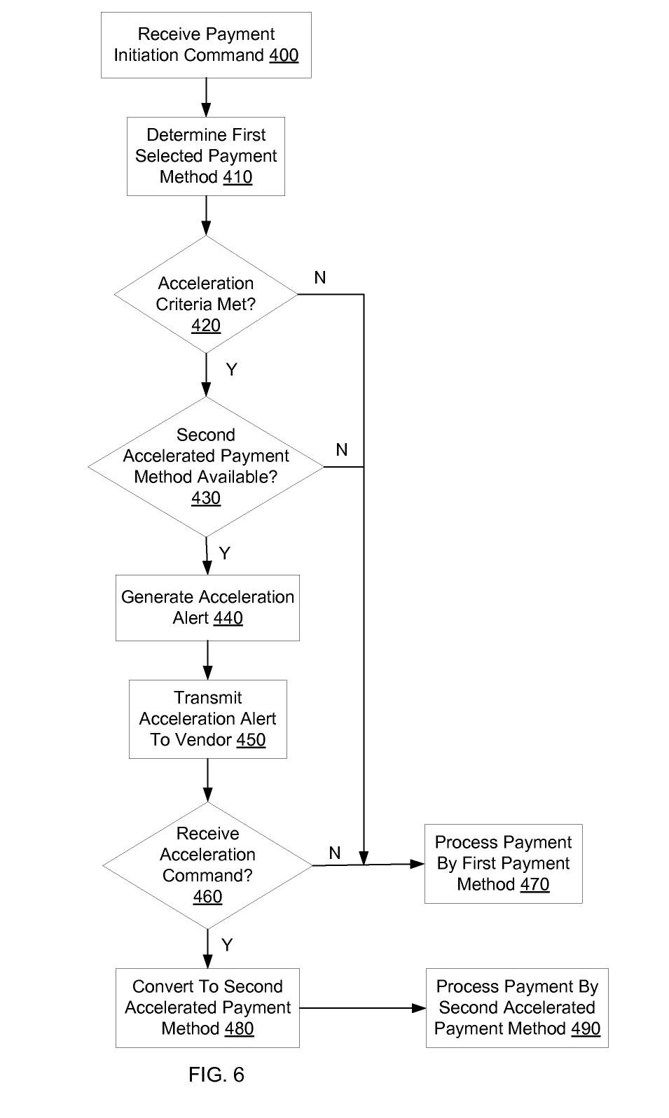

FIG. 6 depicts an overview of a modified exemplary method of accelerating a payment settlement in an invoice transaction system, which can be an alternative to automatic acceleration. As with the method of FIG. 5, in exemplary embodiments of executing the method of FIG. 6, the payment acceleration system 10 of FIG. 1 is configured to execute the described method, such as by the processor 40 executing code embodied as the payment acceleration application 17 stored on the non-transitory computer readable medium 42. Accordingly, in demonstrating the method, reference also is made to the invoice payment system as depicted in FIG. 1, which includes the payment acceleration system 10. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

Initially, the method of FIG. 6 bears similarity to the method of FIG. 5. The method may begin at step 400 (comparable to FIG. 5 step 300), at which a payment initiation command is received by the payment acceleration system from a buyer, which indicates a first payment method (typically selected by the buyer) for paying the invoice. At step 410 (comparable to FIG. 5 step 310), the payment acceleration system 10 determines the selected first payment method, again referred to as the first payment method. At step 420 (comparable to FIG. 5 step 320), the payment acceleration system 10 determines whether or not the invoice associated with the payment meets one or more predetermined criteria. The criteria may be any one or combination of vendor based or service provider/subscription based criteria as described above.

If at step 420 the payment acceleration system renders a “No” determination, indicating that the invoice does not meet the one or more predetermined criteria, the method proceeds to step 470 at which the payment is processed by the first payment method. As above, for example, the payment acceleration system 10 may generate a processing signal and transmit such signal to the electronic invoicing and payment system 9, which would execute the payment with the payment application 19. In such case, there being no basis to accelerate the payment, the payment would be processed in accordance with the first payment method that initially was selected.

If at step 420, however, the payment acceleration system renders a “Yes” determination, indicating that the invoice does in fact satisfy the one or more predetermined criteria, the method proceeds to step 430. At step 430 (comparable to FIG. 5 step 330), the payment acceleration system 10 determines whether or not a second accelerated payment method is available for processing the payment. If at step 430 the payment acceleration system renders a “No” determination, indicating that there is no available second method for payment acceleration, the method proceeds to step 470 at which the payment is processed by the first payment method. In such case, there being no available alternative second method to accelerate the payment, the payment would be processed in accordance with the first payment method that initially was selected. As above, the processor 40 of the payment acceleration system 10 may generate a processing signal and transmit such signal to the electronic invoicing and payment system 9, which would execute the payment with the payment application 19 to process the payment in accordance with the first payment method.

If at step 430, however, the payment acceleration system renders a “Yes” determination, indicating that there is in fact an available second method to accelerate the payment, the method proceeds to step 440. Note that in the previous embodiment of FIG. 5, the result of the previous steps would be the automatic acceleration of the payment by conversion of the first selected payment method to the second accelerated payment method. The method of FIG. 6 differs in that the payment acceleration is not automatic, but rather requires a specific selection by the vendor to accelerate the payment. A vendor selection particularly is suitable for subscription based systems in which the number or scope of payment accelerations may be restricted. In such a system, a vendor can select to accelerate payments as to which payment acceleration would be most beneficial. Relatedly, a vendor may select not to accelerate payments, even when acceleration otherwise may be available, when acceleration may be relatively less beneficial so as not to exhaust the subscription in a less favorable manner.

Accordingly, in the embodiment of FIG. 6, at step 440 the payment acceleration system 10 generates an acceleration alert indicating that a payment is subject to acceleration (i.e., the payment satisfies one or more payment acceleration criteria and a second accelerated payment method is available). At step 450, the acceleration alert is transmitted to the vendor for consideration. For example, the network interface 21 may be configured to transmit the acceleration alert over the network 20 to a vendor workstation (see, e.g., FIG. 3).

At step 460, the payment acceleration system determines whether an acceleration command is received. For example, an acceleration command may be inputted by a vendor at a vendor workstation. The acceleration command would then be transmitted over the network 20 and received by the payment acceleration system 10 via the network interface 21. In other words, the network interface is configured to receive the acceleration command over the network. If at step 460 the payment acceleration system renders a “No” determination, indicating that an acceleration command is not received, the method proceeds to step 470 at which the payment is processed in accordance with the first payment method as initially selected. A “No” determination at step 460 may be based on either an explicit selection made by the vendor not to accelerate the payment (such as by an input at the vendor work station), or by a simple lack of receipt of a command to accelerate. The system may impose a suitable response time, based on the settlement period of the initial versus potential accelerated payment methods, for receiving an acceleration command after which a “No” determination at step 460 will be deemed.

If at step 460, however, the payment acceleration system renders a “Yes” determination, indicating that a payment acceleration command in fact is received, the method proceeds to step 480. At step 480, the payment acceleration system 10 converts the payment method from the first payment method that was initially selected to the second accelerated payment method, as described above with respect to FIG. 5 step 340. Generally again, if the first payment method has a delay period to settlement, and the second payment method has a shorter delay period or near-immediate settlement period, the system will convert the payment method from the first payment method to the second accelerated payment method. If multiple accelerated payment methods may be available, the system may permit the vendor to select the second accelerated payment to be employed from among available accelerated payment methods. For example, a list of available accelerated payment methods may be transmitted to the vendor workstation, as to which a vendor user may input a selection of the desired accelerated payment method.

The method then proceeds to step 490 at which the payment is processed in accordance with the second accelerated payment method. As above, for example, the payment acceleration system 10 may generate a processing signal and transmit such signal to the electronic invoicing and payment system 9, which would execute the payment with the payment application 19 by the second accelerated payment method.

It will be appreciated that although the methods of FIGS. 5 and 6 have been presented as separate methods, such methods may be combined to operate simultaneously. In such embodiments, certain criteria may be may be a basis for triggering automatic acceleration. Certain other criteria may be the basis for triggering an alert to the vendor that acceleration is available, and payment acceleration would occur only upon receipt of an acceleration command from the vendor. Certain other criteria may be dual threshold criteria, in which automatic acceleration may be triggered if the criteria satisfy a first threshold, and alert generation may be triggered if the criteria satisfy a second threshold.

In such an exemplary dual threshold embodiment, the processor 40 further is configured to determine whether the invoice satisfies a first criteria from among the one or more predetermined criteria, and the processor is configured to convert the payment method from the first payment method to the second accelerated payment method automatically when the invoice is determined to satisfy the first criteria. When the invoice does not satisfy the first criteria, however, the processor then determines whether the invoice satisfies a second criteria from among the one or more predetermined criteria. When the processor determines that the invoice satisfies the second criteria, the processor generates an acceleration alert to alert the vendor that the invoice is subject to acceleration. For example, the network interface further is configured to transmit the acceleration alert to the vendor, and to receive a payment acceleration command from the vendor to accelerate the payment. The processor further is configured to convert the first payment method to the second accelerated payment method in response to receipt of the acceleration command. In this manner, the system first determines whether the payment is subject to automatic acceleration, and if not, the payment still may be subject to acceleration upon receipt of a payment acceleration command from the vendor.

For example, payment amount is suitable for being a dual threshold criterion. The first criteria for automatic acceleration may be a first threshold value of an invoice payment amount, and the second criteria for acceleration by vendor acceleration command may be a second threshold value of an invoice payment amount, wherein the first threshold value is greater than the second threshold value. As referenced above, payment acceleration tends to have more value for high value payment amounts. Accordingly, payment amounts meeting a relatively high first threshold value (e.g., $150,000.00) may be deemed of such high value so as to trigger automatic acceleration (assuming an accelerated payment method is available). There may be a range of payment amounts above which payment acceleration may be of significant value, but not of sufficient value for automatic acceleration. In such case, an acceleration alert would be generated to afford the vendor the opportunity to select whether or not to accelerate the payment (again assuming an accelerated payment method is available). In this example, a payment amount meeting a second threshold value (e.g., $50,000.00) but below the first threshold value would be considered of sufficient value to trigger an acceleration alert. Payment amounts below the second threshold value would be deemed by the system to have insignificant value for acceleration, and therefore would be considered by the system as not having met the amount criterion for acceleration at all. In such manner, both the methods of FIGS. 5 and 6 may be employed in combination to provide various circumstances for automatic acceleration versus acceleration alerts.

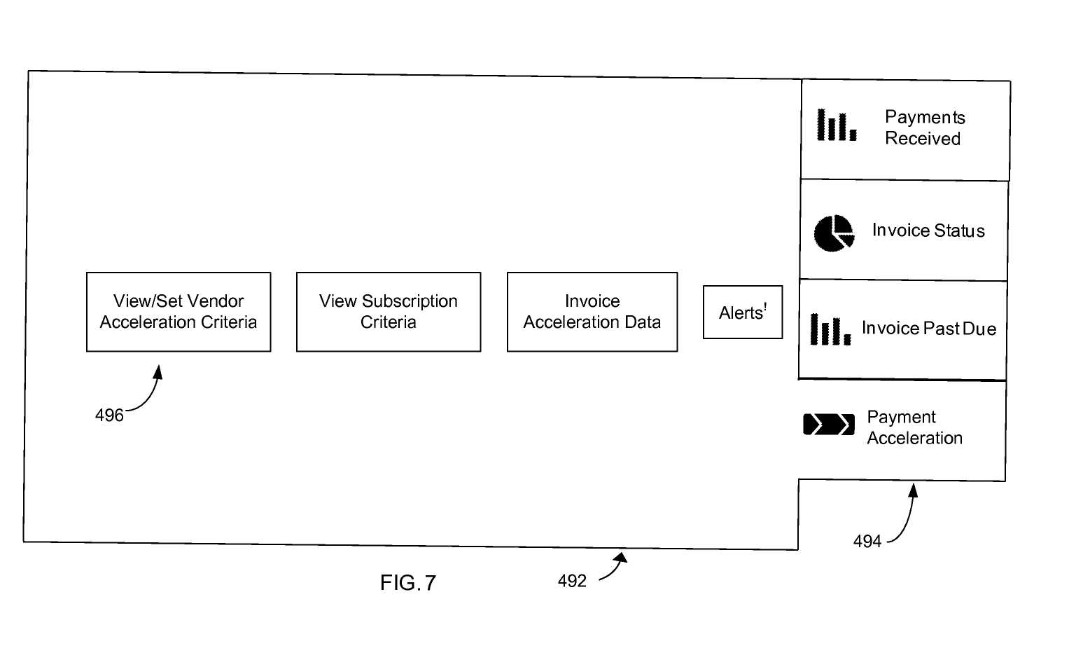

FIG. 7 depicts an exemplary graphical user interface (GUI) 492 for use in connection with an invoice payment system. The GUI 492 may be generated by a service provider operating the invoice and payment system 9 in conjunction with the payment acceleration system 10. For example, the processor 40 may be configured to render display data, using conventional rendering techniques, regarding various invoice information. The display data may be transmitted via the wireless interface 21, and thereby accessible by a vendor using a vendor workstation via the network 20. In such a system, the display data would be rendered on a display of the vendor workstation. Inputs may be provided to the GUI via any suitable input device utilized in connection with the vendor workstation, such as a keyboard, mouse, stylus, touch screen, voice commands, and various others as are known in the art of computer based GUIs. The GUI 492 may include category information tabs 494 that pertain to various aspects of invoicing. One such exemplary category tab is “Payment Acceleration” for use in connection with the various payment acceleration features described herein. It will be appreciated that the GUI of FIG. 7 is an example, and the format and content of the GUI may be varied.

In the example of FIG. 7, the “Payment Acceleration” tab has been selected for usage. Within the GUI, a variety of exemplary command buttons 496 may be provided for a vendor. For example, there may be a command button for “View/Set Vendor Acceleration Criteria”. Selecting such button in the GUI may open a sub-GUI page or window that would permit a vendor to view and enter a variety of vender oriented acceleration criteria as described above. For example, such criteria may include invoice threshold amounts, buyer identity criteria, timing criteria, and other suitable vendor oriented criteria.

Another command button may be “View Subscription Criteria”. Selecting such button in the GUI may open a sub-GUI page or window that would permit a vendor to view a variety of acceleration criteria that are based on the terms of a subscription as described above. For example, such criteria may include subscription or acceleration fees, acceleration quantity amounts, and other suitable acceleration criteria that pertain to terms of a subscription service. This sub-GUI relatedly may permit a vendor to input items or perform transactions related to the subscription. For example, a vendor may be able to pay subscription related fees so as to increase the scope, dollar amounts, and/or number of permissible accelerations and the like.

Another command button may be “Invoice Acceleration Data”. Selecting such button in the GUI may open a sub-GUI page or window that would permit a vendor to view a variety acceleration data pertaining to various invoices. For example, a vendor may view and/or select invoices that potentially could be subject to acceleration, access historical acceleration data, and otherwise monitor acceleration activity for various buyers and invoices.

Another command button may be “Alerts”. Selecting such button in the GUI may open a sub-GUI page or window that would permit a vendor to view and act on alerts pertaining to potential payment accelerations that are transmitted to the vendor as described above. For example, the sub-GUI may permit a vendor to input a selection as to whether or not the vendor wishes to accelerate an invoice or group of invoices. In the example of FIG. 7, the alerts button includes a symbol “!”. Such a symbol or comparable may provide notice to a vendor that new alerts have been received or are present that need action. Other forms of alert notice also may be provided. In addition to various potential visual alerts (e.g., symbols, flashing light or LED, etc.), audible alerts in the form of various alert tones also may be provided so a vendor user is provided notice of receiving an alert even when the vendor user is not viewing the GUI at the precise time the alert is received. It also will be appreciated that a vendor may not always be at a vendor workstation when an alert is generated, and alerts have substantial time sensitivity. Accordingly, alerts (whether visual or audible) may be transmitted to various electronic devices, and particularly mobile devices (e.g., laptop computers, tablets and tablet computers, smart phones, etc.), so that a vendor user can receive the alerts by numerous means. Such portable devices also may permit opening the sub-GUI for viewing and acting on alerts. In this manner, the system permits prompt action on alerts by a vendor from a variety of devices to account for the time sensitivity of alerts.

As referenced above, it will be appreciated that the GUI of FIG. 7 is an example, and the format and content of the GUI may be varied.

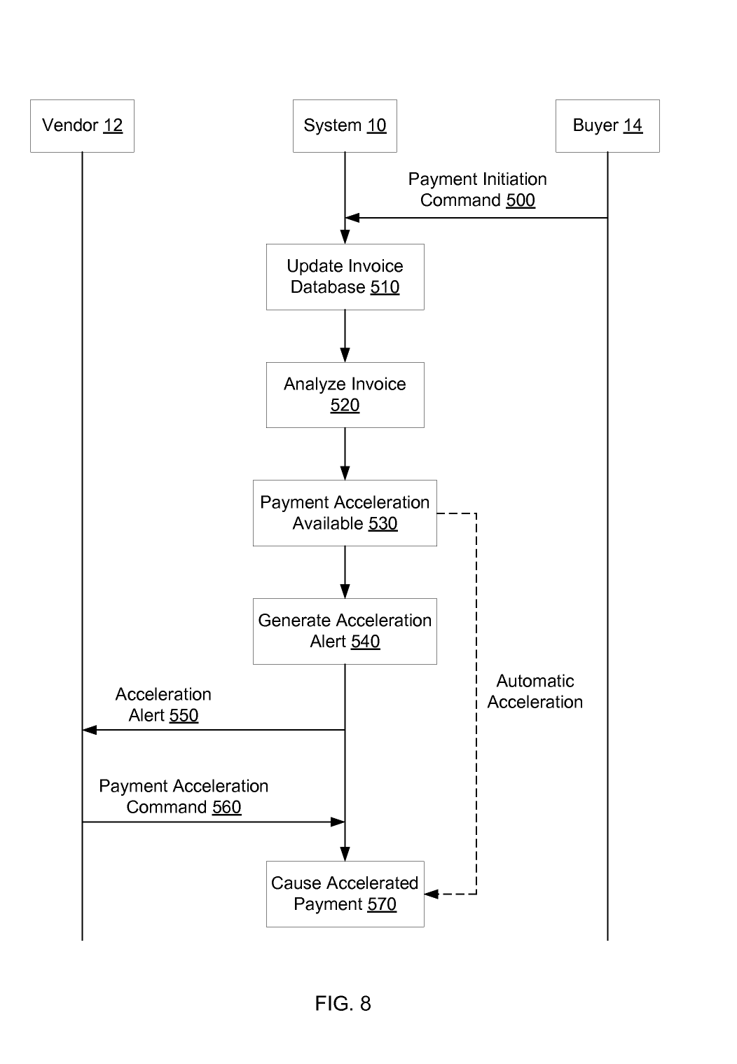

FIG. 8 is a ladder diagram depicting an exemplary embodiment of operation of the payment acceleration system 10 in which a buyer 14 pays an invoice issued by a vendor 12, and the system accelerates the payment to the vendor. In the example of FIG. 8, the buyer executes a payment initiation command 500 for payment of an invoice by a first payment method selected by the buyer. The payment initiation command is received by the payment acceleration system 10, which updates the invoice database at step 510 to indicate the status of the invoice as payment initiated (see also FIG. 4A, block 178).

At step 520, the payment acceleration system 10 analyzes the invoice related to the payment method selected in the payment initiation command, and at step 530 the system renders a decision as to whether payment acceleration is available. When payment acceleration is available, as described above, depending on the applicable criteria being met, one option is automatic payment acceleration. When the invoice and related first payment method satisfy the one or more criteria for automatic payment acceleration, at step 570 the system 10 causes the invoice payment system 9 (see FIG. 1) to process the payment by a second accelerated payment method. The automatic acceleration step is shown as a dotted line in FIG. 8 because automatic acceleration will not always occur, but rather will occur when the invoice specifically satisfies the requisite criteria for automatic acceleration.

At step 540, when automatic acceleration does not occur, the system further may render a decision as to whether an alert to the vendor is to be generated to alert the vendor that an invoice payment satisfies one or more criteria for payment acceleration. If as described above a decision is rendered that the invoice satisfies the one or more criteria for payment acceleration, at step 550 the system 10 generates an acceleration alert and transmits the alert to the vendor 12. At step 560, the vendor may initiate and transmit a payment acceleration command to the system 10, indicating that the vendor has selected to accelerate the payment. At step 570, the system 10 causes the invoice payment system 9 (see FIG. 1) to process the payment by a second accelerated payment method.

Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

What is claimed is:

1. An invoice payment acceleration system comprising:
a database stored on a non-transitory computer readable medium, the database including a plurality of records, each record corresponding to an invoice issued by a vendor for payment from a buyer;
a network interface configured to receive a payment initiation command from a buyer for payment of an invoice to a vendor by a first payment method; and
a processor configured to analyze the invoice as to which the payment command is received to determine whether the invoice satisfies one or more predetermined criteria;
wherein the processor further is configured, when the processor determines that the invoice satisfies the one or more predetermined criteria, to convert the first payment method to a second payment method, and the second payment method provides for an accelerated payment as compared to the first payment method.

2. The invoice payment acceleration system of claim 1, wherein the one or more predetermined criteria comprises vendor preference criteria received from a vendor via the network interface.

3. The invoice payment acceleration system of claim 2, wherein the vendor preference criteria are stored in the database.

4. The invoice payment acceleration system of claim 3, wherein the vendor preference criteria include at least one of a minimum payment amount threshold, a buyer identity, an invoice number, or a timing of the invoice.

5. The invoice payment acceleration system of claim 1, wherein the invoice payment acceleration system is operated by a service provider, and the one or more predetermined criteria comprises service provider terms selected by the service provider.

6. The invoice payment acceleration system of claim 5, wherein the service provider terms criteria are stored in the database.

7. The invoice payment acceleration system of claim 6, wherein the service provider terms criteria include at least one of a minimum threshold of processing fees, a maximum quantity amount of accelerations per unit time, or a maximum invoice dollar amount per unit time.

8. The invoice payment acceleration system of claim 1, wherein the one or more predetermined criteria includes whether or not the second accelerated payment method is available for processing the payment.

9. The invoice payment acceleration system of claim 1, wherein the first payment method is an automated clearing house transaction and the second payment method is a wire transfer.

10. The invoice payment acceleration system of claim 1, wherein the processor is configured to convert the payment method from the first payment method to the second payment method automatically when the invoice is determined to satisfy the one or more predetermined criteria.

11. The invoice payment acceleration system of claim 1, wherein:
the processor further is configured, when the processor determines that the invoice satisfies the one or more predetermined criteria, to generate an acceleration alert to alert the vendor that the invoice is subject to acceleration;
the network interface further is configured to transmit the acceleration alert to the vendor;
the network interface further is configured to receive an acceleration command from the vendor to accelerate the payment; and
the processor further is configured to convert the first payment method to the second payment method in response to receipt of the acceleration command.

12. The invoice payment acceleration system of claim 1, wherein the processor further is configured to cause the payment to be processed in accordance with the first payment method when the invoice does not satisfy the one or more predetermined criteria.

13. The invoice payment acceleration system of claim 11, wherein the processor further is configured to cause the payment to be processed in accordance with the first payment method when an acceleration command is not received.

14. The invoice payment acceleration system of claim 1, wherein the processor further is configured to:
determine whether the invoice satisfies a first criteria from among the one or more predetermined criteria; and
convert the payment method from the first payment method to the second payment method automatically when the invoice is determined to satisfy the first criteria.

15. The invoice payment acceleration system of claim 14, wherein:
the processor further is configured, when the invoice does not satisfy the first criteria, to determine whether the invoice satisfies a second criteria from among the one or more predetermined criteria;
the processor further is configured, when the processor determines that the invoice satisfies the second criteria, to generate an acceleration alert to alert the vendor that the invoice is subject to acceleration;
the network interface further is configured to transmit the acceleration alert to the vendor;
the network interface further is configured to receive an acceleration command from the vendor to accelerate the payment; and
the processor further is configured to convert the first payment method to the second payment method in response to receipt of the acceleration command.

16. The invoice payment acceleration system of claim 15, wherein the first criteria is a first threshold value of an invoice payment amount, and the second criteria is a second threshold value of an invoice payment amount, wherein the first threshold value is greater than the second threshold value.

17. An electronic invoice and payment system comprising:
the invoice payment acceleration system of claim 1, and
an invoice payment system configured to process the payment in accordance with the second accelerated payment method when the processor determines that the invoice satisfies the one or more predetermined criteria.

18. The electronic invoice and payment system of claim 17, wherein the processor further is configured to cause the payment to be processed in accordance with the first payment method when the invoice does not satisfy the one or more predetermined criteria; and
the invoice payment system is configured to process the payment in accordance with the first payment method when the processor determines that the invoice does not satisfy the one or more predetermined criteria.

19. A method of accelerating an invoice payment in an electronic invoice payment system comprising the steps of:
storing a database on a non-transitory computer readable medium, the database including a plurality of records, each record corresponding to an invoice issued by a vendor for payment from a buyer;
receiving a payment initiation command over a network interface from a buyer for payment of an invoice to a vendor by a first payment method; and
providing a payment acceleration application on a non-transitory computer readable medium, which when executed by a processor performs the steps of:
analyzing the invoice as to which the payment command is received to determine whether the invoice satisfies one or more predetermined criteria;
wherein when it is determined that the invoice satisfies the one or more predetermined criteria, converting the first payment method to a second payment method, and the second payment method provides for an accelerated payment as compared to the first payment method.

20. The method of accelerating an invoice payment of claim 19, wherein the payment acceleration application when executed by the processor further performs the steps of:
when it is determined that the invoice satisfies the one or more predetermined criteria, generating an acceleration alert to alert the vendor that the invoice is subject to acceleration;
transmitting the acceleration alert to the vendor via the network interface;
receiving an acceleration command from the vendor via the network interface to accelerate the payment; and
converting the first payment method to the second payment method in response to receipt of the acceleration command.
